(19) United States
(12) Patent Application Publication
(10) Pub. No.: US 2009/0281233 A1
(43) Pub. Date: Nov. 12, 2009

(54) SOLUTION POLYMERIZATION PROCESS AND ADHESIVE, SEALANT, AND MASTIC COMPOSITIONS MADE THEREFROM

(76) Inventors: Mark A. Vrana, Lancaster, OH (US); Sandipan Dutta, Hilliard, OH (US); Nicholas J. Ford, Columbus, OH (US); Denny Doyle, Lancaster, OH (US); Tobias N. Thompson, Delaware, OH (US); David E. Wortman, Marysville, OH (US); E. Jeffrey Davis, McArthur, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/436,564

(22) Filed: May 6, 2009

Related U.S. Application Data
(60) Provisional application No. 61/127,289, filed on May 12, 2008.

(51) Int. Cl. C08L 31/04; C08F 118/08

(52) U.S. Cl. 524/563; 526/319

(57) ABSTRACT

A process for making VOC-compliant adhesives, sealants, or mastic compositions for use in residential and industrial construction applications, and the products made thereby utilizing VOC-compliant solvents in the polymerization process.

### CROSS REFERENCE TO RELATED APPLICATIONS

This application claims the benefit of U.S. Provisional Application No. 61/127,289, filed May 12, 2008, which is incorporated by reference.

### FIELD OF THE INVENTION

The present invention relates to a process for making VOC-compliant adhesive, sealant, and mastic compositions, particularly those utilized in residential and industrial construction-related applications, and products made using the same. The applications for such compositions include, but are not limited to, bonding and sealing of plywood, OSB, MDF, particleboard, lumber, drywall, and other building materials based on wood, plastic, metal, and cement.

### BACKGROUND OF THE INVENTION

Given recent emphasis on hazardous air pollutants and indoor air quality, it has become desirable to provide products in general, and in particular, adhesive, sealant and mastic compositions of the type that are used in the construction industry, that are VOC compliant. Further, in order to provide such products at a commercially viable price, it is desirable to utilize a process for making such compounds that preferably requires the fewest amount of steps and least amount of energy, labor, and raw materials to create. Thus, while prior art processes for making such compounds generally involved the separate steps of acquiring a solid polymer, dissolving said polymer in solvent to form a polymer solution, then formulating said polymer solution into the desired composition, a fully integrated process wherein the base polymer is polymerized and formulated in-situ is desired. In the prior art process, the solid polymer is typically purchased, having been prepared through a polymerization process and energy-intensive drying process. In the fully integrated process, the polymer is prepared in the desired solvent or solvent blend and used without further refinements (and thus does not require separate steps of manufacturing, drying, transporting, and re-dissolving the polymer in solvent to create the polymer solution).

### SUMMARY OF THE INVENTION

The invention is a process for making VOC-compliant adhesive, sealant, or mastic compositions for use in residential and industrial construction applications, and the products made thereby. Specifically, the process and products made in accordance with the present invention are preferably made using a solution polymerization process and subsequent compounding process that does not require the separate step of dissolving solid polymers in solution. More specifically, in accordance with the present invention, a polymer is preferably first polymerized in the desired VOC-compliant (exempt) solvent or solvent blend, then used without further processing, drying, re-dissolving, or etc., to prepare the final products. The solution polymer may then be simply compounded with fillers, additives, modifiers, colorants, and other functional or inert ingredients to form the finished product as is known in the art. Thus, in one embodiment, the present invention may be distinguished from prior art processes in that instead of purchasing a solid polymer (typically thermoplastic polymers, such as styrene-butadiene based rubbers) that has already been prepared by another manufacturer through polymerization in organic solvents or water and dried in an energy-intensive process, the process of the present invention polymerizes the desired polymer (typically a vinyl acrylic copolymer) in-situ. As such, the process of the present invention (as well as the sealant, mastic or adhesive compositions made thereby) eliminate not only the energy-intensive drying step of the prior art, but the packaging and shipping of the solid polymer to the manufacturer of those compositions where it must be re-dissolved in a solvent and subsequently compounded to form the finished product. Given that all of the foregoing steps as required by the prior art process added significantly to the overall energy consumption and costs of preparing the finished construction product, the present invention, being a fully integrated process, provides substantial benefits over those prior art processes.

### DETAILED DESCRIPTION OF THE INVENTION

In one embodiment of the invention, it is an objective to provide a process for the preparation of copolymers of vinyl acetate and acrylate monomers in a VOC-compliant (exempt) solvent via a traditional polymerization process in which a desirable reaction profile and degree of monomer conversion are achieved along with acceptable polymer mechanical and adhesive properties. It should be appreciated that from a standpoint, non-exempt organic solvents (VOC's) are acceptably included in the composition. However, since the invention relates to low VOC or zero VOC formulations, they may be included only in small amounts in the finished product. Commonly used solvents that are classified as VOC's include N-methyl pyrolidinone, dimethyl formamide, methyl ethyl ketone, toluene, methanol, ethanol, hexane, etc., and mixtures thereof. Solvents such as tertiary butyl acetate, methyl acetate, acetone, and others, are included in the composition as VOC-compliant (exempt) solvents.

In another embodiment in accordance with the present invention, a low VOC solution polymer composition is provided that may be used in the manufacture of adhesives, sealants, and mastics. The solution polymer is comprised of a solvent, monomers that lend themselves to free-radical polymerization, and an initiating compound or system of compounds capable of generating free radicals. The solution polymerization process that is used may be any of a number of solution polymerization processes known to those of ordinary skill in the art and that are commonly used and practiced by industrial manufacturers of solution polymers. Another embodiment of the invention provides an adhesive, sealant, or mastic composition that contains any or all of the following ingredients: a solution polymer, plasticizers, fillers, resins, and low level additives such as antioxidants, wetting agents, crosslinkers, and etc.

In another preferred embodiment, a solution polymer in accordance with the present invention may be prepared in a VOC-compliant (exempt) solvent or solvent mix such as methyl acetate solvent or a blend of methyl acetate and acetone. This solution polymer is preferably based predominately on vinyl acetate monomer, with low to moderate levels of N-butyl acrylate monomer and a functional monomer, such as iso-butoxymethyl acrylamide. It may then be preferably compounded with clay, calcium carbonate, plasticizer, rosin acid resin, antioxidant, and other ingredients (or a combination of the above), into the finished product. The finished adhesive, sealant, or mastic product preferably contains less than 100 g/L of VOC, more preferably less than 50 g/L of VOC, and achieves sufficient tensile and/or shear strength, such as is described in the requirements of AFG-01, ASTM D3498, ASTM C557-93a, or other applicable industry and environmental standards.

In order to make the formulated products disclosed herein, the solution polymer must first be made. The synthetic process for preparing the solution polymer is preferably a one-stage process, and it is preferably carried out in a single reaction vessel. This is referred to as a batch process. The batch process may be carried out by charging all of the monomers and some or all of the solvents into the reactor, adding a polymerization initiator and, if required, a polymerization regulator, and heating to the required initiation temperature. Typically, the reaction is carried out under reflux of the solvent or solvent blend, and this assists in maintaining a uniform reaction temperature. Alternatively, a semi-continuous process can be used. In this process, a portion of the monomers and some or all of the solvent are charged into the reactor. Initiator is added and the reactor is heated to the initiation temperature. Once the desired reaction conditions have been achieved, the rest of the monomer(s) and solvent(s) are added semi-continuously to complete the polymerization. To achieve an acceptable degree of monomer conversion, an additional charge or charges of initiator at later stages of the process are often required. It can also be beneficial to use a different initiator, or blend of initiators, from that employed during the early stages of the run. The degree of monomer conversion is generally preferred to be around 98-99%.

Any solution polymerization techniques that are common and well known in the art may be used within the scope of the present invention. The solution polymer preferably constitutes from about 20% to about 70% by weight of polymer solids in the solvent or solvent blend, wherein the polymer solids comprise a monomer or mixture of monomers capable of free radical polymerization, about 0 to 5 parts of a post-crosslinkable monomer per 100 parts of monomer, and a compound or combination of compounds capable of generating free radicals. Polymer compositions for use within the scope of the invention include, but are not limited to, the following: homopolymers of vinyl acetate; copolymers of vinyl acetate and esters of acrylic acid, preferably n-butyl, 2-ethyl hexyl, ethyl, and iso-butyl; homopolymers and co-polymers made from all acrylic monomers including esters of acrylic and methacrylic acid, where n-butyl, 2-ethyl hexyl, ethyl, and iso-butyl are the preferred acrylic acid esters, and methyl and n-butyl are the preferred methacrylic acid esters; polymers and copolymers of styrene and the acrylic monomers; and copolymers of vinyl acetate and the vinyl esters of versatic acids. In addition to pure monomers, preformed polymers, polymeric intermediates, multifunctional epoxides, melamines and isocyanates, can be included in the reactor charge and/or post addition.

As is known in the art, crosslinking and post-crosslinking monomers can be employed in polymerization to tailor the properties of polymers and formulated polymer-based products. Crosslinking monomers provide a means to generate higher molecular weights during the polymerization process, whereas post-crosslinking monomers provide a means to generate higher molecular weights and fully crosslinked (thermoset) structures in the end use of the polymer (after application of the finished adhesive, sealant, or mastic product). Crosslinking monomers include, but are not limited to, diacrylates, triacrylates, dimethacrylates, and trimethacrylates. Post-crosslinking monomers include, but are not limited to, N-methylol acrylamide, acrylamide, acrylic acid, methacrylic acid, monomers containing silane, or glycidyl methacrylate. Both crosslinking and post-crosslinking monomers may be used singly or in combination within the scope of the invention. The initiating compounds may include, but are not limited to, the group of compounds which generate free radicals through thermal decomposition, such as organic peroxides, as well as the group of compounds which generate free radicals via a redox reaction.

An embodiment of the invention is a construction adhesive, sealant, or mastic prepared by compounding the solution polymer with fillers to improve economics, improve rheological properties, and increase strength. Fillers which are common and well known in the art are useful as fillers in the present invention. Examples of such fillers include calcium carbonate, aluminum silicate, talc, silica, ground up polymers and the like, and mixtures thereof. Such fillers frequently reinforce the mastics/sealant. Optionally, modifying resins may be used to improve adhesion and other performance properties. Modifying resins which are useful in the formulation of this invention are generally those which are well known in the art, such as modified and unmodified rosin and rosin esters, esters of polymerized rosin, polyterpene resins, terpene-phenolic resins, coumarone-indene resins, diolefin-olefin resins, phenol-aldehyde resins, aromatic resins, and the like. Pigments are frequently employed in the formulations for the aesthetic value as well as their reinforcing properties. Any pigments can be employed to impart the desired coloration. Carbon black and titanium dioxide are well known pigments suitable for such use. It is usually desirable to include stabilizers in the formulations. Such stabilizers include well known antioxidants and anti-ozonants, as well as ultraviolet and thermal stabilizers. Hindered phenols, substituted phosphites, phenolic phosphites, dialkyl thiodipropionates, nickel dialkyldithiocarbamates, and the like, and mixtures thereof, are examples of stabilizers which are particularly beneficial in the present invention. The level of solvent in the overall composition is dependent on the quantity and type of additives used. Solvent level is adjusted to achieve the desired open time and to meet various other performance requirements.

In accordance with the present invention an adhesive, sealant, or mastic product from a solution polymer may be prepared as follows. A portion of the solution polymer, typically 35-65% by weight, is charged into a high shear mixer capable of incorporating the dry ingredients in such a manner as to yield a smooth, high viscosity mastic. With agitation, the dry ingredients are charged and mixed until dissolved and/or rendered smooth and relatively free of grit. The typical order of addition of the ingredients is liquid plasticizer, resinous additives, antioxidant, fillers, chosen from materials such as clay, silica, calcium carbonate, or talc, and special additives, such as, but not limited to, crosslinking agents, additional specialty solvents, acid scavengers, and etc. The mastic composition is mixed in a very high viscosity, high shear state until all materials are dissolved, free of grit, and homogenous. The remainder of the solution polymer is then added to complete the composition, diluting the compound to its proper final viscosity. The composition is again mixed until homogenous.

The viscosity and rheology of the resultant compound may be important to its use. Thixotropy or pseudoplasticity may be important for some applications; Newtonian flow for others. After the mixing is complete, physical testing must first be performed. Viscosity measurements are made using a Brookfield Viscometer, using a t-bar spindle, D-F, with a Heliopath attachment, at various rpm, depending upon the rheology desired. Solids content may also be measured, using high heat to evaporate the solvent(s).

Performance testing may be performed on the finished product based on the end-use requirements of the particular product. Specifically, construction products are generally tested for tensile and/or shear strength, free film characteristics, adhesion to specific substrates, shelf stability, utility at various temperatures, and oxidation resistance. Some must pass application requirements, such as trowelability and troweled open time. In addition, a number of Industry or ASTM specifications exist for products used in specific applications. Subfloor or Construction Adhesives must pass the requirements of American Plywood Association Specification AFG-01, and may be required to pass ASTM D3498, a HUD-driven version of the APA Spec. Adhesives for drywall and panel applications are required to pass ASTM C557. The adhesives must show excellent adhesion to plywood, lumber, and drywall. Moreover, for a Construction Adhesive to meet the AFG-01 and/or ASTM D3498 performance requirements, it has to be capable of adhering to plywood and lumber under a variety of conditions. The present compositions will wet out on wet lumber and plywood and are freeze-thaw stable, thus allowing the adhesive to be exposed to freezing conditions after application without affecting the performance. Upon thawing, the adhesives continue to adhere to the substrates until the full bonding strength is achieved.

### ILLUSTRATIVE EXAMPLES IN ACCORDANCE WITH THE INVENTION

### Solution Polymers A-E

The formulas for solution polymers A-E are shown below in Table 1. The reactions were carried out in a 2 liter glass kettle fitted with a vertical water condenser, a liquid temperature probe for measuring and controlling the reaction temperature, and a variable speed 4-blade pitched blade turbine agitator. For polymers A-B, the process was run semi-continuously. The kettle was placed in a temperature controlled water bath with an overflow port, a cooling water input, and a heating coil. The initiator solution was prepared and contained in a 20 ml glass vial. The kettle charge of solvent and monomers was weighed into kettle. The kettle charge was heated to 59° C. and then 1 gram of the initiator solution was added. The reaction was continued for 1 hour, with another 1 gram of initiator solution added at the 30 minute mark. A temperature rise from 59 to 63° C. was observed during this 1 hour period. At times, the reaction exotherm may increase the temperature of reaction up to 66° C., but this will typically recede to 62-63° C. in 10 minutes or less. There was a noticeable rise in the solution viscosity as the reaction is carried out. After 1 hour, the monomer feed (containing monomer, or monomer and solvent) was started; the addition time was 45 minutes. After starting the feed, 1 gram of the initiator solution was immediately added. After 30 minutes, an additional 1 gram of the initiator solution was added. The final monomer solution was prepared and contained in a 20 ml glass vial. 30 minutes after the monomer feed was complete, 4.43 grams of the final monomer solution was added along with 0.5 gram of the initiator solution. After 15 minutes, an additional 4.43 grams of the final monomer solution was added. After 15 additional minutes, the remaining 4.43 grams of the final monomer solution was added. At this point, the reaction mass was very viscous. 150 grams of Acetone was added over 15 minutes of time, and the kettle temperature stabilized at 59-60° C. 1 gram of initiator solution was added to the reactor, the reaction was monitored for 15 minutes. This process was repeated two more times (for a total addition of 3 grams of initiator solution, 45 minutes of reaction time). The temperature remained at approximately 60 to 61 C. The reaction was continued for another 30 minutes, after which cooling was started. When the temperature reached 48° C., the last dose of 0.5 grams of initiator solution was added. The kettle was cooled to room temperature and the product was discharged. The total reaction time was approximately 4.5 hours.

### Solution Polymers C-E

The polymerization reactions for Polymers C, D, and E were carried out in laboratory equipment identical to that described above. The process used for these, however, was a batch process. That is, all of the monomers and some of the solvent were added as a kettle charge, and there was no feed stage. For this type of process, the kettle charge was heated to the reflux temperature of around 60° C. and then 1.55 grams of the initiator solution was added into the kettle. A temperature rise of 2-6° C. was observed. After 30 minutes, another 1.55 grams of initiator solution was added to the kettle. After an additional 30 minutes, another 1.55 grams of initiator solution was added. At this point, the reaction mass for Polymers D and E was very viscous, so Acetone or Methyl acetate (200 grams and 50 grams, respectively) was added over a 15 minute interval. The temperature remained at approximately 59-61° C. during this time. 1 gram of initiator solution was then added to the reactor (1.5 grams for Polymer E), and the reaction was allowed to proceed for 30 minutes. This process was repeated two more times for a total of three additions of initiator solution, totaling 3 grams (4.5 grams for Polymer E), and 1.5 hours of reaction time. Next, 1 gram of initiator solution and 1.73 grams of reducer solution were added to the reactor. After 30 minutes, 0.5 grams of initiator solution and 1.73 grams of reducer solution were added and the reaction was allowed to proceed for an additional 15 minutes. The final charge of 0.5 grams of initiator solution and 1.73 grams of reducer solution was added to the kettle. No reducer solution was used for Polymers C or E. After 15 minutes, cooling was applied to the reactor and the product temperature was reduced to room temperature over about 20 minutes of time. The product was then discharged from the vessel.

TABLE 1
Formulas for Solution Polymers A-E (all values in grams)

| | Polymer | Polymer | Polymer | Polymer | Polymer |
|---|---|---|---|---|---|
| Component | A | B | C | D | E |
| Kettle Charge | | | | | |
| Methyl acetate | 150 | 485 | 485 | 150 | 150 |
| Vinyl acetate | 225 | 181 | 430 | 325 | 210 |
| monomer | | | | | |
| n-Butyl acrylate | 10 | 25 | 68 | 4 | 6 |
| SR 210 | 0.7 | 0 | 0 | 2 | 1.4 |
| (polyethyleneglycol | | | | | |
| dimethacrylate) | | | | | |
| VV-10 (vinyl ester of | 0 | 5 | 0 | 0 | 2.8 |
| versatic acid 10) | | | | | |
| Iso-butoxymethyl | 0 | 0 | 0 | 4 | |
| acrylamide | | | | | |
| Methacylic acid | 0 | 0 | 0 | 0 | 2.1 |
| Initiator Solution | | | | | |
| Perkadox 16S | 1.2 | 1.3 | 1.3 | 1.3 | 1.7 |
| (Di(4-tert- | | | | | |
| butylcyclohexyl)- | | | | | |
| peroxydicarbonate) | | | | | |
| Trigonox C | 0 | 0 | 0 | 0.2 | 0 |
| Methyl acetate | 9 | 0 | 0 | 0 | 13 |
| Acetone | 0 | 10 | 10 | 10 | 0 |
| Monomer Feed | | | | | |
| VV-10 | 5 | 0 | 0 | 0 | 0 |
| Vinyl acetate | 100 | 249 | 0 | 0 | 0 |
| monomer | | | | | |
| n-Butyl acrylate | 5 | 42 | 0 | 0 | 0 |
| Acetone | 0 | 175 | 0 | 0 | 0 |
| Final Monomer | | | | | |
| Solution | | | | | |
| VV-10 | 5 | 0 | 0 | 0 | 0 |
| n-Butyl acrylate | 7 | 0 | 0 | 0 | 0 |
| SR 210 | 1.3 | 0 | 0 | 0 | 0 |
| Reducer Solution | | | | | |
| Erythorbic Acid | 0 | 0 | 0 | 1.2 | 0 |
| Water | 0 | 0 | 0 | 4 | 0 |
| Final Solvent Charge | | | | | |
| Acetone | 150 | 0 | 0 | 200 | 0 |
| Methyl Acetate | 0 | 0 | 0 | 0 | 50 |

### ILLUSTRATIVE EXAMPLES OF ADHESIVE/SEALANT/MASTIC PRODUCTS IN ACCORDANCE WITH THE INVENTION

### Examples 1-8

The previously described solution polymers were formulated into construction-type products and tested for their physical and performance properties. Table 2 provides a summary of the basic formulas prepared and tested. To prepare the products, 35-65 wt. % of the solution polymer was charged into a high shear mixer. With the agitation running, the plasticizer was added, followed by the wetting agent, antioxidant, and fillers. The mastic composition was then mixed in a very high viscosity, high shear state until all the materials were dissolved and the product was homogenous and free of grit. The remainder of the solution polymer was then added, plus additional solvent (as required) and thickener, to complete the composition and achieve the desired final viscosity. Mixing was continued until the product was homogenous.

TABLE 2
Adhesive/Sealant/Mastic Formulations (all values in grams)

| | Example | | | | | | | | | |
|---|---|---|---|---|---|---|---|---|---|---|
| | 1 | 2 | 3 | 4 | 5 | 6 | 7 | 8 | 9 | 10 |
| Solution | A | B | C | D | E | E | E | E | E | E |
| Polymer | | | | | | | | | | |
| Solution | 60 | 60 | 60 | 60 | 53 | 56 | 57 | 54 | 53 | 47 |
| Polymer | | | | | | | | | | |
| Kaolin Clay | 20 | 20 | 20 | 20 | 36 | 37 | 33 | 36 | 35 | 35 |
| Calcium | 20 | 20 | 20 | 20 | 0 | 0 | 0 | 0 | 0 | 0 |
| Carbonate | | | | | | | | | | |
| Plasticizer | 6 | 6 | 6 | 6 | 8 | 8 | 9 | 9 | 6 | 8 |
| Methyl | 0 | 0 | 0 | 0 | 3 | 0 | 0 | 0 | 4 | 8 |
| Acetate | | | | | | | | | | |
| Antioxidant | 0.5 | 0.5 | 0.5 | 0.5 | 0.5 | 0.5 | 0.5 | 0.5 | 0.5 | 0.4 |
| Wetting Agent | 0 | 0 | 0 | 0 | 0 | 0 | 0 | 0 | 0.5 | 2 |
| Thickener | 0 | 0 | 0 | 0 | 0 | 0 | 0 | 0 | 0.5 | 0 |

The formulations were drawn into films using a 100 mils draw bar, dried for 7 days at room temperature plus 7 days at 49° C., then qualitatively evaluated for general physical/mechanical properties. Table 3 provides a summary of the data for the dried product films. Dynamic mechanical analyses were also performed on the products to assess usability at the service temperature. The storage modulus vs. temperature curves for the inventive products were compared with that of a commercial control, and the data provides the storage modulus at a practical service temperature of 40° C. From the data it is apparent that the subject of this invention, new VOC-compliant construction adhesives/sealants/mastics, possess similar physical/mechanical properties to those of an established, commercially available product. On average, the new polymers are slightly softer than the commercial control, particularly at elevated temperatures (40° C.). Accordingly, they show, on average, enhanced elongation, recovery, and impact resistance. The commercial control utilized in this work was a construction-type mastic product available as Franklin International Heavy Duty Construction Adhesive.

TABLE 3
Adhesive/Sealant/Mastic Properties (Dried Films)

| | Example | | | | |
|---|---|---|---|---|---|
| | Control | 1 | 2 | 3 | 4 |
| Flexibility | Very | Very | Very | Very | Very |
| | Good | Good | Good | Good | Good |
| Strength | Very | Very | Very | Very | Good |
| | Good | Good | Good | Good | |
| Elongation | Fair | Good | Good | Good | Very |
| | | | | | Good |
| Tear Resistance | Good | Good | Good | Good | Good |
| Recovery | Fair | Good | Good | Good | Good |
| Impact | Fair | Good | Good | Good | Good |
| Storage | 50.6 | 38.2 | 34.4 | 19.1 | 35.9 |
| modulus @ 40° C. | | | | | |
| (MPa) | | | | | |

Example

| | 5 | 6 | 7 | 8 |
|---|---|---|---|---|
| Flexibility | Very | Very | Very | Very |
| | Good | Good | Good | Good |
| Strength | Very | Very | Very | Very |
| | Good | Good | Good | Good |
| Elongation | Fair | Fair | Fair | Fair |
| Tear Resistance | Good | Very | Good | Very |
| | | Good | | Good |
| Recovery | Fair | Good | Fair | Good |
| Impact | Fair | Good | Good | Poor |
| Resistance | | | | |
| Storage | 24.8 | 11.6 | 16.9 | 25.2 |
| modulus @ 40° C. | | | | |
| (MPa) | | | | |

Formulations 5-8 were analyzed for various physical and application properties. The tests included viscosity, rheology/slump, low temperature extrusion, green grab, adhesive transfer (legging), open time, and etc. The results are summarized in Table 4 along with the results for a commercially available control (Franklin International Heavy Duty Construction Adhesive). From the data it is apparent that the novel products, on average, possess similar physical and application properties to those of an established, commercially available product.

TABLE 4
Adhesive/Sealant/Mastic Physical/Application Properties (Wet State)

| | Example | | | | |
|---|---|---|---|---|---|
| | Control | 5 | 6 | 7 | 8 |
| Viscosity (cps) | 130,000 | 151,000 | 150,250 | 163,750 | 142,500 |
| Slump, ½″ V bead | No Slump | No Slump | Slight | No Slump | No Slump |
| Low Temp Extrusion (0° F.) | Fairly Easy | Fairly Easy | Slightly | Moderately | Easy |
| | | | Difficult | Difficult | |
| Green Grab | Good | Good | Good | Good | Good |
| Legging | Good | Good | Good | Good | Good |
| Open Time, ½″ V bead (min) | 65 | >65 | >65 | >65 | 45 |
| Open Time, troweled (min) | 40 | 42 | 40 | 40 | 40 |
| VOC Content (g/L) | 282 | 21.9 | 22.4 | 21.6 | 69 |

Formulations 5-8 were qualitatively evaluated for adhesion performance on a variety of common building materials. Films of the products were drawn onto the various substrates using a 100 mils draw bar and allowed to dry for 7 days at room temperature plus 7 days at 49° C. The films were then scored with a utility knife/razor, and thin strips of the films were peeled from the substrate using a small laboratory spatula. Adhesion was rated on the basis of difficulty of removal of the film. All tests were conducted on at least two different lots of product prepared with different lots of solution polymer. The data presented in Table 5 represents the most favorable results achieved in these studies. Franklin International Heavy Duty Construction Adhesive was tested as a control product. From the data it is apparent that the subject of this invention, new VOC-compliant construction adhesives/sealants/mastics, on average, possess similar adhesion properties to those of an established, commercially available product.

TABLE 5
Adhesion Performance on Building Materials

| | Example | | | | |
|---|---|---|---|---|---|
| | Control | 5 | 6 | 7 | 8 |
| Cold Rolled | Very | Fair | Fair | Fair | Fair |
| Steel | Good | | | | |
| Galvanized | Good | Fair | Fair | Fair | Fair |
| Steel | | | | | |
| Aluminum | Good | Fair | Fair | Fair | Fair |
| Copper | Good | Excellent | Excellent | Excellent | Good |
| Concrete | Good | Fair | Fair | Fair | Good |
| Paver Block | Good | Good | Good | Good | Good |
| ABS | Fair | Fair | Fair | Fair | Fair |
| FRP | Fair | Fair | Fair | Fair | Fair |
| PVC | Fair | Poor | Fair | Poor | Fair |
| Acrylic | Excellent | Excellent | Excellent | Excellent | Excellent |
| Poly- | Good | Excellent | Very | Excellent | Excellent |
| carbonate | | | Good | | |

Formulations 5-8 were quantitatively tested for rate of strength build up and ultimate bond strength on wood substrates. Evaluations were conducted using a Franklin internal cross-lap shear test method. In this test, 1.5 in. by 5 in. by 0.75 in thick wooden blocks were bonded in a perpendicular fashion to form cross-laps with an overlap area of 1.5 in by 1.5 in. After preparation, the blocks are allowed to cure for periods of 1, 3, 7, 14, 21, and 56 days, then tested by loading in tension on an MTS test frame. The results on pressure treated lumber, given in lbs., are shown in Table 6, along with the results for a commercially available control (Franklin International Heavy Duty Construction Adhesive). From the data, it is apparent that the novel products achieve performance comparable to that of an established, commercially available product.

TABLE 6
Cross-lap Shear Results on Pressure Treated Lumber

| | Example | | | | |
|---|---|---|---|---|---|
| | Control | 5 | 6 | 7 | 8 |
| Timeframe | Load-lbs. | Load-lbs. | Load-lbs. | Load-lbs. | Load-lbs. |
| 1 day | 363 | 643 | 553 | 472 | 555 |
| 3 days | 605 | 675 | 586 | 592 | 597 |
| 7 days | 622 | 606 | 650 | 579 | 416 |
| 14 days | 848 | 365 | 596 | 428 | 491 |
| 21 days | 513 | 247 | 366 | 204 | 291 |
| 56 days | 618 | 333 | 351 | 467 | 452 |

Formulation 9 was evaluated for performance according to the full requirements of American Plywood Association Specification AFG-01. This is a demanding industry test that includes evaluations on saturated and saturated/frozen lumber to simulate the extreme conditions that may be encountered on a construction site. The results, summarized in Table 7, clearly demonstrate that the inventive products achieve acceptable performance in all portions of this test.

TABLE 7
AFG-01 Test Results (load in lbs.)

| Example | 9 | Required |
|---|---|---|
| Wet Lumber | 303 | 225 |
| Frozen Lumber | 197 | 150 |
| Gap Fill | 356 | 150 |
| Dry | 611 | 225 |
| Moisture | 340 | 225 |

What is claimed is:

1. A process for preparing an adhesive, sealant, or mastic composition comprising the steps of:
preparing a polymer in solution, wherein the polymer is polymerized in-situ in a solvent or solvent blend and wherein the polymer is not dried prior to incorporation in the finished product;
blending the polymer solution with fillers, additives, and other ingredients to obtain the finished adhesive, sealant or mastic product.

2. An adhesive, sealant or mastic prepared by the process of claim 1

3. The process of claim 1 wherein said step of preparing the polymer in solution includes the step of preparing the polymer in a solution comprised of the solvent or solvent blend to be used in the finished product.

4. The process of claim 1 wherein said step of preparing the polymer in solution includes the step of preparing the polymer in a solution that does not include the solvent or solvent blend to be primarily used in the finished product and includes the step of exchanging the solvent or solvent blend with a VOC-compliant solvent or solvent blend prior to incorporation of the polymer in solution into the finished product.

5. The process of claim 1 further including the step of selecting a VOC-compliant solvent or solvent blend for said preparation of the polymer in solution.

6. The process of claim 5 wherein said VOC-compliant solvent selecting step further includes the step of selecting a solvent from the group consisting of tertiary butyl acetate, methyl acetate, and acetone or a combination thereof.

7. The process of claim 5 wherein the VOC-compliant solvent is methyl acetate, acetone, or a combination thereof.

8. The adhesive, sealant or mastic of claim 2 wherein the VOC content in the finished product is less than about 100 g/L.

9. The adhesive, sealant or mastic of claim 2 wherein the VOC content in the finished product is less than about 50 g/L.

10. The process of claim 1 wherein the polymer is prepared from monomers capable of free radical polymerization.

11. A process for preparing an adhesive, sealant, or mastic composition comprising the steps of:
preparing a polymer in solution, wherein the polymer is polymerized in-situ in the solvent or solvent blend used in the finished product and wherein the polymer is not dried prior to incorporation in the finished product;
blending the polymer solution with fillers, additives, and other ingredients to obtain the finished adhesive, sealant or mastic product.

12. An adhesive, sealant or mastic prepared by the process of claim 11

13. The process of claim 11 further including the step of selecting a VOC-compliant solvent or solvent blend for said preparation of the polymer in solution.

14. The process of claim 13 wherein said VOC-compliant solvent selecting step further includes the step of selecting a solvent from the group consisting of tertiary butyl acetate, methyl acetate, and acetone or a combination thereof.

15. The process of claim 13 wherein the VOC-compliant solvent is methyl acetate, acetone, or a combination thereof.

16. The adhesive, sealant or mastic of claim 12 wherein the VOC content in the finished product is less than about 100 g/L.

17. The process of claim 11 wherein the polymer is prepared from monomers capable of free radical polymerization.

18. The process of claim 11 wherein the steps are completed using a batch process.

19. The process of claim 11 wherein the steps are completed using a continuous or semi-continuous process.

20. An adhesive, sealant or mastic composition compounded from a base comprising vinyl acetate monomer polymerized in methyl acetate.
